(19) United States
(12) Patent Application Publication
(10) Pub. No.: US 2026/0085005 A1
(43) Pub. Date: Mar. 26, 2026

(54) ALGAL BIOCHAR FOR REDUCTION OF HEAVY METAL LEACHATE FROM MINE TAILINGS

(71) Applicants: Elham Fini, Phoenix, AZ (US); Farideh Pahlavan, Chandler, AZ (US)

(72) Inventors: Elham Fini, Phoenix, AZ (US); Farideh Pahlavan, Chandler, AZ (US)

(21) Appl. No.: 19/337,409

(22) Filed: Sep. 23, 2025

Related U.S. Application Data
(60) Provisional application No. 63/697,690, filed on Sep. 23, 2024.

(51) Int. Cl. C04B 18/12; C04B 18/10; C04B 28/00; C04B 103/00; C04B 103/10; C04B 111/00

(52) U.S. Cl. CPC C04B 18/12; C04B 18/101; C04B 28/006; C04B 2103/0078; C04B 2103/10; C04B 2111/00784

(57) ABSTRACT

A composite includes biochar and a base material including mine tailings. Preparing the composite includes combining a base material including mine tailings and an alkali activator to yield a mixture, polymerizing the mixture to yield a geopolymer material, and combining the geopolymer material and biochar to yield the composite.

### CROSS-REFERENCE TO RELATED APPLICATION

This application claims the benefit of U.S. Patent Application No. 63/697,690 filed on Sep. 23, 2024, which is incorporated by reference herein in its entirety.

### STATEMENT OF GOVERNMENT SUPPORT

This invention was made with government support under 1928795 awarded by the National Science Foundation. The government has certain rights in the invention.

### TECHNICAL FIELD

This invention relates to a composite derived from microalgae to immobilize ions of heavy metals.

### BACKGROUND

Mine tailings are the materials left over after desired fractions are removed from mined ores. Mine tailings typically include toxic substances, such as heavy metals and sulfides. In some cases, mine tailings include radioactive components.

### SUMMARY

This disclosure describes a composite including biochar and mine tailings for use in construction materials. The biochar, which immobilizes ions of heavy metals in the mine tailing, can be algal biochar obtained through hydrothermal liquefaction of Cyanidioschyzon merolae. Density functional theory (DFT) and experimental results are used to elucidate the molecular interactions involved in metal adsorption onto algal biochar. Ultraviolet-visible (UV-Vis) spectroscopy shows metal-ion adsorption independent of solution pH, and thermogravimetric analysis reveals changes in thermal stability, indicating chemical interactions between biochar and metal ions. The dominant mechanisms of adsorption are identified as cation-π interactions, complexation, and ion exchange. The stability of the adsorption at various pH levels and temperatures suggests strong binding affinity. The DFT analysis shows competitive adsorption with the selectivity order of copper (Cu²⁺)>iron (Fe²⁺)>zinc (Zn²⁺), displacing inherent cations such as potassium (K). At least in part because of the ability of algal biochar to adsorb heavy metal ions, it can be used as an additive to construction materials (e.g., geopolymer material, asphalt, brick) incorporating mining tailings to reduce leaching of heavy metals from the mine tailings.

In a first general aspect, a composite includes a base material including mine tailings and biochar.

Implementations of the first general aspect can include one or more of the following features. The base material can include clay, laterite, zeolite, volcanic ash, natural pozzolans, fly ash, red mud, furnace slag, rice husk ash, waste incinerator bottom ash, silica fume, waste glass, coal gangue, or a combination thereof. In some cases, the mine tailings include one or more heavy metals. The one or more heavy metals can include Cr. Co, Ni, Cu, Zn, Mn, Mo, Rh, Pd, Cd, In, Sn. Ti, As, Sr, Ag, Fe, Bi, Pt, Pb, or a combination thereof. In some implementations, the one or more heavy metals include Cu. The biochar can be derived from hydrothermal liquefaction. In some cases, the biochar has a selectivity order of Cu²⁺>Fe²⁺>Zn²⁺ for adsorption. In some implementations, the K⁺ ions of the biochar are displaced from a nitrogen site of amines, amides, or a combination thereof. The biochar can include algal biochar. In some cases, the algal biochar is derived from Cyanidioschyzon merolae. The first general aspect can further include aggregate. The first general aspect can include about 55 wt % to about 80 wt % of the aggregate. In some implementations, the first general aspect further includes an alkali activator. The alkali activator can include NaOH, KOH, LiOH, Na₂SiO₃, Na₂CO₃, K₂CO₃, Li₂CO₃, CaO, NaAlO₂, AlCaO, Al₂CaO₄, or a combination thereof. In some cases, the first general aspect includes about 0.3 wt % to about 30 wt % of the biochar. In some implementations, the first general aspect includes about 10 wt % to about 35 wt % of the base material.

In a second general aspect, preparing a composite includes combining a base material including mine tailings and an alkali activator to yield a mixture, polymerizing the mixture to yield a geopolymer material, and combining the geopolymer material and biochar to yield the composite.

Implementations of the second general aspect can include one or more of the following features. In some cases, the base material includes clay, laterite, zeolite, volcanic ash, natural pozzolans, fly ash, red mud, furnace slag, rice husk ash, waste incinerator bottom ash, silica fume, waste glass, coal gangue, or a combination thereof. In some implementations, the alkali activator includes NaOH, KOH, LiOH, Na₂SiO₃, Na₂CO₃, K₂CO₃, Li₂CO₃, CaO, NaAlO₂, AlCaO, or Al₂CaO₄, or a combination thereof. In certain cases, the biochar includes algal biochar.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1A is a flow chart showing operations in a process to prepare a composite FIGS. 1B and 1C show a schematic representation of algal biochar functional groups and electrostatic potential energy (ESP) molecular surface map for algal biochar, respectively. PAH stands for polyaromatic hydrocarbon.

FIG. 2 shows three potential mechanisms involved in the adsorption of heavy-metal ions by algal biochar.

FIG. 3 shows comparisons of density functional theory (DFT)-based adsorption energy showing the interaction of heavy-metal ions (e.g., Cu²⁺, Zn²⁺, and Fe²⁺) with algal biochar through cation-π, complexation, and ion-exchange mechanisms.

FIG. 4 shows an ultraviolet-visible (UV-Vis) absorption spectrum of algal biochar (algae BC) in dichloromethane:ethanol (8:2, v/v) displaying a characteristic absorption band at 275 nm.

FIGS. 5A-5C show the UV-Vis absorption spectra of algal biochar in the presence of FeCl₂, CuCl₂, and ZnCl₂, respectively, along with metal and biochar controls displaying distinct spectroscopic profiles that are not characteristic of the corresponding metal salt and the biochar, suggesting interactions between the metal and algal biochar (BC).

FIG. 6A shows thermogravimetric analysis (TGA) (top) and differential thermal gravimetry (DTG) (bottom) curves of algal biochar showing thermal degradation profiles upon heating to 1000° C. The curves indicate the degradation of labile content predominantly below 500° C., resulting in approximately 40% residual mass.

FIG. 6B shows differential scanning calorimetry (DSC) (top) curve overlaid with the TGA (bottom) curve of algal biochar, showing an exothermic reaction throughout the heating process. FIGS. 6C and 6D show TGA and DTG curves of algal biochar and metal-salt complexes, alongside controls. Additionally, the TGA and DTG curves for the metal salts alone are shown. The curves show temperature-dependent decomposition, highlighting the release of volatile compounds and the breakdown of labile and non-labile organic matter.

FIGS. 7A-7D show TGA/DTG (top/bottom) curves of algal biochar in the presence of FeCl₂, CuCl₂, ZnCl₂, and FeCl₂+CuCl₂+ZnCl₂, respectively. The curves display evolution of volatiles and some content of recalcitrant carbon at different temperatures.

FIGS. 8A-8C show UV-Vis absorption spectra of algal biochar in the presence of FeCl₂, CuCl₂, and ZnCl₂, respectively, at different concentrations (10 mM, 5 mM, 4 mM, 3 mM, 2 mM, and 1 mM) along with metal and biochar controls displaying distinct spectroscopic profiles that are not characteristic of the corresponding metal salt and the biochar, suggesting plausible interactions between the metal and algal biochar.

FIGS. 9A-9C show UV-Vis absorption spectra of algal biochar (algae BC) in the presence of FeCl₂, CuCl₂, and ZnCl₂, respectively, at different pH levels (6, 2, and 9) along with metal and biochar controls displaying stability in the case of CuCl₂ and ZnCl₂. However, in the case of FeCl₂, the metal ion was observed to be leaching from the biochar surface in acidic pH.

FIGS. 10A-10C show UV-Vis absorption spectra of algal biochar (algae BC) in the presence of FeCl₂, CuCl₂, and ZnCl₂, respectively, at different pH (6, 5, 4, 3, and 2) along with metal and biochar controls, displaying stability in the case of CuCl₂, and ZnCl₂; however, in the case of FeCl₂, the metal ion was observed to be leaching from the biochar surface at pH=2, indicated by observance of the characteristic FeCl₂ absorption at 360 nm.

FIG. 11 shows UV-Vis absorption spectra of algal biochar (algae BC) in the presence of FeCl₂, CuCl₂, and ZnCl₂, respectively, in distilled water along with metal and biochar controls recorded in water.

FIGS. 12A-12C show UV-Vis absorption spectra of the treated algal biochar (algae BC) with FeCl₂, CuCl₂, and ZnCl₂, respectively, at different temperatures (20, 40, 60, 80 and 100° C.) along with metal and biochar controls, displaying stability in a diverse temperature range.

FIGS. 13A-13C show UV-Vis absorption spectra of the treated algal biochar (BC) with FeCl₂, CuCl₂, and ZnCl₂, respectively, after different time intervals (24, 48 and 72 hours) along with metal and biochar controls, displaying stability after 72 hours at room temperature.

### DETAILED DESCRIPTION

This disclosure describes a composite including biochar and mine tailings, where the biochar immobilizes heavy metal ions in the mine tailings. In some examples, the biochar is algal biochar obtained through hydrothermal liquefaction of Cyanidioschyzon merolae. “Biochar” is a combination of two words, “bio” meaning “biomass” and “char” meaning “charcoal.” Biochar is characterized by a high surface area, spongy structure, along with functional groups (e.g., carboxylic, carbonyl, ester, hydroxyl, phenolic, pyridine, pyrrole, and quaternary amine). When incorporated in construction material that include mine tailings, algal biochar can reduce the leaching of heavy metals from the construction material.

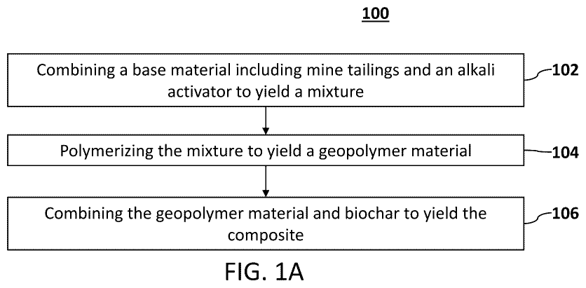

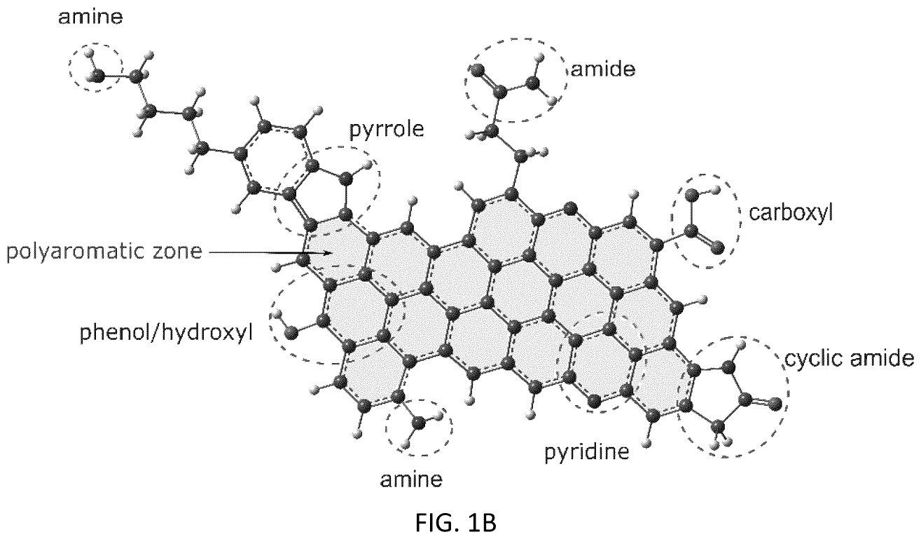

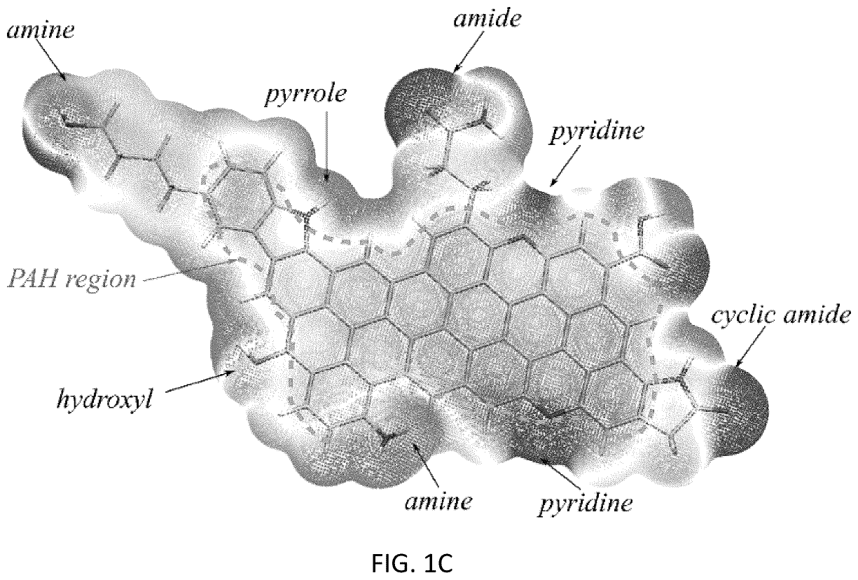

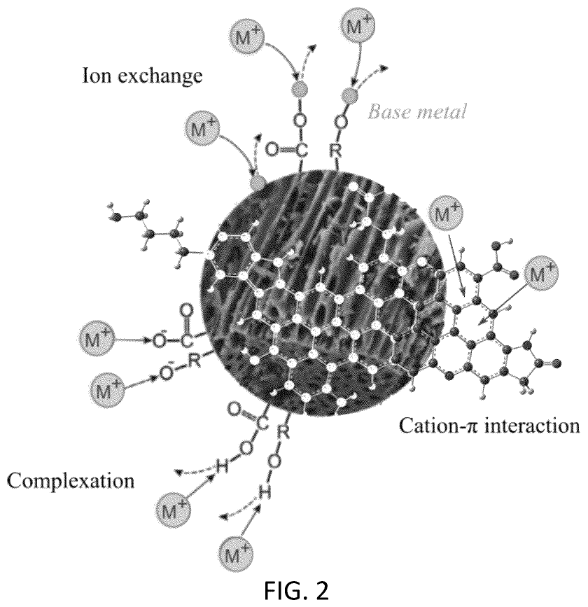

FIG. 1A is a flow chart showing operations in a process 100 to prepare a composite. In 102, a base material including mine tailings is combined with an alkali activator to yield a mixture. In 104, the mixture is polymerized to yield a geopolymer material. In 106, The geopolymer material and biochar is combined to yield the composite. Suitable examples of the base material include clay, laterite, zeolite, volcanic ash, natural pozzolans, fly ash, red mud, furnace slag, rice husk ash, waste incinerator bottom ash, silica fume, waste glass, coal gangue, or a combination thereof. The alkali activator can include NaOH, KOH, LiOH, Na₂SiO₃, Na₂CO₃, K₂CO₃, Li₂CO₃, CaO, NaAlO₂, AlCaO, or Al₂CaO₄, or a combination thereof. In some implementations, the biochar includes, consists essentially of, or consists of algal biochar.

Mine tailings, the residual byproducts of mining operations, are abundant and pose waste-management issues. The use of mine tailings as a feedstock for producing construction materials offers a pathway to resource conservation and waste valorization. However, due at least in part to the abundance of metal compounds (e.g. Cr, Co, Ni, Cu, Zn, Mn, Mo, Rh, Pd, Cd, In, Sn, Ti, As, Sr, Ag, Fe, Bi, Pt, and Pb) in mine tailings, there are concerns about their leachate. The leachate of metal ions from the construction material can vary depending on the manufacturing process and on the end application. Metal leachates can contaminate soil and water, posing environmental and health risks. Therefore, immobilizing these metals is desired for the safe use of mine tailings in construction materials.

Geopolymers can be used as a substitute for ordinary Portland cement at least in part because of similar binding properties and the lower CO₂ emissions of geopolymers. Geopolymers can be used in buildings and infrastructures such as wastewater facilities, retention tanks, soil stabilization, highways, marine installations, and sea walls, each of which is exposed to different environmental stressors. Geopolymers are alkali-bonded aluminosilicate materials with three-dimensional amorphous polymeric structures. They are synthesized through geopolymerization, which typically uses alkali to activate silicon dioxides and aluminum oxides, leading to the formation of a polymeric network. This process creates geopolymers with interconnected Si—O—Al—O—Si bonds and negative charges neutralized by positive ions. Suitable examples of positive ions include potassium (K⁺):sodium (Na⁺), calcium (Ca²⁺), and lithium (Li⁺). The advantages of geopolymers over ordinary Portland cement include rapid development of mechanical strength, high resistance to acids, negligible expansion from alkali-silica reactions, and improved durability. Environmentally, geopolymers reduce greenhouse-gas emissions and can immobilize heavy metals within a stable matrix. These features make geopolymers an attractive material for various construction applications, providing high strength, low shrinkage, chemical resistance, and fire resistance.

The production of geopolymers utilizes raw materials rich in silicon dioxide (SiO₂) and aluminum oxide (Al₂O₃). Due at least in part to the high aluminosilicate content of mine tailings, they can serve as a sustainable and effective raw material for geopolymer production. Geopolymerization offers a method of stabilizing and solidifying mine tailings, recycling waste and creating sustainable building materials while also stabilizing toxic elements. Suitable mine tailings include, for example, copper mine tailings. The mechanical properties of geopolymers made with mine tailings can meet industry specifications for certain construction applications. This in turn qualifies these geopolymers for use in buildings as well as infrastructures (e.g., wastewater facilities, retention tanks, roads, marine installations, sea walls, and bridges).

In some cases, geopolymers are made from mine tailings and an additional base material rich in SiO₂ and Al₂O₃. Non-limiting examples of these base materials include clay, laterite, zeolite, volcanic ash, natural pozzolans, fly ash, red mud, furnace slag, rice husk ash, waste incinerator bottom ash, silica fume, waste glass, coal gangue, or a combination thereof.

The process of geopolymerization typically includes the following: the dissolution of aluminosilicate materials in a concentrated alkali base solution to form the free silica and the alumina tetrahedron unit; the transfer, solidification/gelation of materials, the condensation reaction of alumina and silica hydroxyl to form the inorganic geopolymer gel phase; and condensation of the gel phase to form a three-dimensional network of silicoaluminate that forms a geopolymer.

Activators play a role in the geopolymerization process. Higher concentrations of activators typically lead to higher dissolution rates of silicon (Si⁴⁺) and aluminum (Al³⁺) ions in aluminosilicate materials when compared with the lower activator concentrations, which in turn favor higher degree of geopolymerization. In some examples, the activators are included in the base material. Non-limiting examples of alkali base activators include NaOH, KOH, LiOH, Na₂SiO₃, Na₂CO₃, K₂CO₃, Li₂CO₃, CaO, NaAlO₂, AlCaO, or Al₂CaO₄, or a combination thereof. The curing temperature also impacts geopolymerization, as the dissolution of raw materials can be accelerated with higher temperature.

The incorporation of biochar (e.g., algal biochar) in geopolymers can help reduce metal concentrations below industry thresholds, which can vary depending on the end application of the geopolymer. Integrating biochar can encapsulate heavy metals within the matrix, enhancing the geopolymer's environmental performance. In some cases, incorporating biochar produced from the microalgae Cyanidioschyzon merolae into copper mine tailings-based geopolymers can trap heavy metals within the biochar structure, minimizing the risk of leaching.

The capacity of algal biochar to selectively adsorb copper (Cu²⁺), iron (Fe²⁺), and zinc (Zn²⁺) ions, commonly found in copper mine tailings, is described. To assess the efficacy and mechanisms of heavy-metal adsorption by algal biochar, quantum-based molecular modeling using density functional theory (DFT) is used. This is complemented by characterization techniques such as thermogravimetric analysis (TGA) and ultraviolet-visible (UV-Vis) spectroscopy. TGA results provide insight into the thermal stability and degradation behavior of the biochar, showing how metal interactions alter its thermal properties. UV-Vis spectroscopy studies offer observations of changes in biochar's absorption profile upon interaction with metals, reinforcing the understanding of the adsorption process. Together, these comprehensive characterizations and analyses elucidate the underlying mechanisms driving the removal of heavy metals by biochar.

The presence of base cations, such as potassium, calcium, magnesium, and sodium play a role in metal adsorption through ion exchange. DFT calculations support the competitive adsorption of heavy metals, with the order of Cu²⁺>Fe²⁺>Zn²⁺, as they displace cations such as K⁺.

The examination of cation-π interactions between heavy-metal ions (Zn²⁺, Cu²⁺, and Fe²⁺) and the polyaromatic core of algal biochar provide insight into the mechanisms of metal sequestration. Cu²⁺ exhibited the strongest affinity at least in part because of its [Ar] 3d9 electronic configuration, which promotes effective π-backbonding with the biochar's aromatic system. Zn²⁺ displays a weaker interaction at least in part because of its fully filled [Ar] 3d10 configuration, limiting its ability to form robust π complexes.

The molecular modeling reveals positional preferences of metal ions on the polyaromatic system. Fe²⁺ and Zn²⁺ predominantly favor the central position above a single benzene ring, while Cu²⁺ prefers the junction of three benzene rings at least in part because of the ability of Cu²⁺ to form multicenter cation-π interactions.

DFT calculations show that nitrogen-containing functional groups in algal biochar play a role in effective heavy-metal adsorption. Nitrogen-containing functional groups (e.g., amines, amides, and pyridines) facilitate ion-exchange mechanisms with heavy metal ions, showing a stronger affinity for these metals than oxygen-containing groups. The co-presence of both nitrogen and oxygen functional groups in algal biochar likely promotes a synergistic effect, enhancing the overall capacity for heavy-metal adsorption.

UV-Vis spectroscopic studies show that algal biochar exhibits selective adsorption capabilities, evidenced by changes in the absorption profiles when treated with FeCl₂ or CuCl₂. In some cases, shoulder peaks at 256 nm and 325 nm for FeCl₂ and a shoulder peak at 255 nm for CuCl₂ indicate specific interactions such as cation-π interactions, exchange interactions, and other metal-binding mechanisms.

Thermogravimetric analysis show changes in the thermal degradation profile of algal biochar in the presence of metal salts, indicating interactions between metal ions and the biochar. The absence of characteristic endothermic peaks in metal-treated algal biochar suggests the formation of complexes between metal ions and the biochar's functional groups, supported by altered results for measurements of thermal events and heat flow. In some examples, FeCl₂-treated biochar showed a 6.6% mass loss at 170-200° C., while CuCl₂-treated and ZnCl₂-treated biochars had mass losses of 46% and 37%, respectively, at broader temperature ranges. These findings suggest varying adsorption affinities and capacities of algal biochar for different metals, which can be utilized for targeted metal immobilization in construction applications.

### EXAMPLES

### Density Functional Theory (DFT)-Based Molecular Modeling

A molecular model of the biochar surface can provide an insight into the interactions between algal biochar and the target heavy metals, thereby shedding light on the selective adsorption process. As shown in Table 1, a molecular model was designed to reflect the elemental composition and functionalities of algal biochar. The model included the two primary features of biochar: a carbonaceous skeleton, and surface functional groups.

TABLE 1
Elemental analysis of the algal biochar
Elemental analysis (wt. %)

| C | H | N | O |
|---|---|---|---|
| 41.5 ± 0.41 | 3.99 ± 0.14 | 4.18 ± 0.19 | 50.33 ± 1.14 |

X-ray diffraction peaks (e.g., 26.426° and 43.019° (20)) indicated the presence of graphite-like carbon in biochar that was produced via hydrothermal liquefication of Cyanidioschyzon merolae algae biomass. The temperature range used during the liquefaction process (e.g., 300-350° C.) was used to predict the presence of disordered polyaromatic clusters in the biochar structure, which was used to inform the computational molecular model.

The types of chemical bonds and atomic ratios extracted from Fourier-transform infrared spectroscopy (FTIR) were also utilized to inform the computational model. The high protein content in algal feedstock increased the concentration of nitrogen, which promoted the formation of N-functional groups in the biochar; the presence of carbohydrates in the microalgae composition can enhance nitrogen retention in biochar during the thermochemical conversion of the biomass. FTIR results indicated that algal biochar has nitrogen functional groups as well as oxygen functional groups such as carbonyl, ketene, phenol, and carboxyl. An N—H stretching peak was detected in the range of 1600 cm⁻¹ to 1670 cm⁻¹. Additionally, the minor peaks detected between 2100 cm⁻¹ and 2270 cm⁻¹ in pure algae and mixed samples can be attributed at least in part to amides and ketones. Using FTIR, the chemical bonds and functional groups adorning the central polyaromatic region were determined. These functional groups, identified as components in the adsorption capacity of the biochar, became central features in the molecular model. As shown in FIG. 1B, a schematic representation of algal biochar identifies numerous N-functional groups. The integration of these functional groups into the model contributed to understanding the mechanisms of heavy-metal adsorption and the influence of these functional groups on the selective adsorption process.

### DFT Energy Analysis

This computational modeling explored how different metals (Cu, Fe, and Zn) interacted with the biochar surface. This allowed the understanding of not only the adsorption capabilities of the biochar, but also which metals are preferentially adsorbed in the presence of a mixture of these metals. The DMol3 module of the Accelrys Materials Studio program package was used to optimize the structure of algal biochar and the complexes formed upon adsorption of heavy metals. To identify the biochar's active sites that facilitate metal adsorption and evaluate the thermodynamic stability of the resulting complexes of biochar and heavy metal, long-range van der Waals and electrostatic interactions were considered. This includes incorporating Grimme's long-range dispersion correction into the Perdew-Burke-Ernzerhof (PBE) functional of the generalized gradient approximation (GGA), or PBE-D. In the optimization process, all-electron double-numerical basis sets were used, inclusive of polarization functions. Calculations were conducted at the “Fine” level of numerical integration with tolerances for energy, maximum force, and displacement convergence set at 1.0×10⁻⁵ Hartree, 2.0×10⁻³ Hartree/Å, and 5.0×10⁻³ Å, respectively.

Multiple possible mechanisms were explored for metal adsorption over biochar. For an adsorption complex of biochar and a heavy metal, the thermodynamic stability is determined by calculating the adsorption or binding energy (E_{ads}), defined as the difference between the energy of the adsorbed state and the sum of the energies of the components in their isolated states. For a two component system of a heavy-metal ion and biochar, the adsorption energy is shown in Equation 1.

$${E}_{ads} = {E}_{adsorbed} - ( {E}_{metal} + {E}_{biochar} ) \qquad ( 1 )$$

In this equation, E_{adsorbed} represents the total energy of the system when the components are in the adsorbed or bound state, while Eₘₑₜₐₗ and E_{biochar} denote the energies of the metal ion and biochar, respectively, when they are isolated and at thermodynamic equilibrium. If the adsorption energy of a bound system yields a negative value, it suggests a positive energy shift in the adsorbed state compared to the isolated state, indicating that adsorption is thermodynamically viable. Stronger adsorption is indicated by a more negative value of adsorption energy.

To understand the interaction between algal biochar and metal ions, DFT calculations were used to visualize the electrostatic potential (ESP) on the van der Waals surface of biochar. ESP maps highlight regions of positive and negative ESP, indicating potential ion-binding sites. Using the optimized biochar structure, the program Multiwfn was used to generate wave-function files at the PBE/6-31G* level with Gaussian 16 and compute ESP values. The ESP surfaces were visualized using Visual Molecular Dynamics, as shown in FIG. 1C.

The ESP maps revealed molecular polarity in the algal biochar, due at least in part to nitrogen-carrying functional groups. This polarity likely enhanced non-covalent interactions with metal ions, highlighting the role of nitrogen functional groups in immobilizing metals and preventing their leaching. These maps visually confirm the molecular model, showing how nitrogen and oxygen functional groups influence the charge distribution of the biochar. Donor atoms are likely to attract positively charged metal ions. This visualization reinforced the molecular model, highlighting biochar regions conducive to adsorption of metal ions. Understanding these details provided an insight into optimizing the adsorption process and predicting binding sites for metal ions.

Unless specified otherwise, all reagents were acquired commercially at reagent grade and were used as received without additional purification. Reagents and solvents were sourced from Sigma-Aldrich, Fisher Scientific, and VWR International. High-performance liquid chromatograph (HPLC)-grade acetonitrile was obtained specifically from Fisher Scientific. Metal salts were procured exclusively from Sigma-Aldrich. Algal biochar was produced using hydrothermal liquefaction at a temperature of 330° C. and solid loading of 20 wt. % algae. Procedures for hydrothermal liquefaction and separation can be found in the literature. Ultraviolet-visible (UV-Vis) absorbance spectra were collected using a Shimadzu UV-Vis-NIR 3600 spectrophotometer and a quartz cuvette with a 1-cm path length. Thermogravimetric analysis-differential scanning calorimetry measurements were performed on a Mettler Toledo, following the standard protocols.

A sample of algal biochar was exposed to different metal salts at a moderately high temperature to compare the interactions between the metal ions and the biochar spectrophotometrically. Five milligrams of algal biochar were weighed into each of three separate 1-dram glass vials (VWR glass vials, Catalog No. 470151-622). Ten-millimolar stock solutions of FeCl₂, CuCl₂, and ZnCl₂ were prepared in 15-mL scintillation vials using a dichloromethane:ethanol (8:2 v/v) mixture. One milliliter of the stock solution for each metal was added to the 1-dram glass vials containing the biochar sample. After placing a PTFE-coated stir bar (VWR spinbar micro, 3×10 mm, Catalog No. 58948-375) into each vial, the vials were tightly capped and sealed with parafilm. The vials were stirred at 50° C. for 48 hours. Subsequent to the incubation period, the samples were analyzed using UV-Vis absorbance spectrophotometry.

To prepare samples for thermogravimetric analysis, metal salts were used. Before thermal analysis, the pristine and treated biochar was solubilized in a dichloromethane:ethanol (8:2 v/v) solvent system and the biochar was filtered and dried, to obtain finely ground dry material. To evaluate thermal stability, 25-40 mg of the biochar was weighed into a 70-μL alumina (Al₂O₃) pan with an aluminum lid. The autosampler removed the lid when the sample was placed on the balance to maintain accurate sample mass and to reduce sample deliquescence while waiting for analysis. The lid also ensured consistent mass when the samples were in the autosampler tray. A reference measurement was taken with an empty alumina pan. Under a nitrogen flow of 50 mL/min, samples were heated from 25° C. to 1000° C. at a ramp rate of 10° C./min. The carrier gas in the thermal stability experiments was nitrogen (N₂) and a flow rate of 50 mL/min was used. The thermal stability of the biochar (both in the absence and presence of metal salts) was characterized using thermogravimetric analysis (TGA) and differential thermal gravimetry (DTG), with peak temperatures indicating the degradation of labile and non-labile components. Differential scanning calorimetry (DSC) provided insight into stability through peak temperatures, peak heights (expressed in mW or W/g), and the total heat of the reaction (ΔH) in J/g.

The effect of different concentrations of the metal stock on the interactions between the metal ions and biochar was assessed spectrophotometrically. Samples of a few milligrams of algal biochar were treated with different concentrations of metal salts at 50° C. To begin, 5 mg of algal biochar were weighed into each of 18 separate 1-dram glass vials (VWR glass vials, Catalog No. 470151-622). Stock solutions (10 mM, 5 mM, 4 mM, 3 mM, 2 mM, and 1 mM) of FeCl₂, CuCl₂, and ZnCl₂ were prepared in 15 mL scintillation vials using a dichloromethane:ethanol (8:2 v/v) solvent system. A set of 6 different 1-dram vials containing the biochar sample were charged with 10, 5, 4, 3, 2, and 1 mM stock solution for FeCl₂. Another set of 6 1-dram vials containing 5 mg biochar were subjected to 10, 5, 4, 3, 2, and 1 mM stock solution for CuCl₂. The last set of 6 1-dram vials were subjected to 10, 5, 4, 3, 2, and 1 mM stock solution for ZnCl₂. After placing a PTFE-coated stir bar (VWR spinbar micro, 3×10 mm, Catalog No. 58948-375) into each vial, the vials were tightly capped and sealed with parafilm. The vials were stirred at 50° C. for 48 hours. Subsequent to the incubation period, the samples were analyzed using UV-Vis absorbance spectrophotometry.

The effect of different pH levels on the interactions between the metal ions and the biochar was assessed spectrophotometrically. 5-mg samples of algal biochar were placed into each of nine separate 1-dram glass vials (VWR glass vials, Catalog No. 470151-622) and treated with 1-mM metal salts at 50° C. at different pH levels. Stock solutions of FeCl₂, CuCl₂, and ZnCl₂ were prepared in 15 mL scintillation vials using a dichloromethane:ethanol (8:2 v/v) mixture, and 1 mL of the stock solution was then transferred into the 1-dram glass vials containing the weighed biochar samples. The pH of each solution was adjusted using 6 M H₂SO₄ and 6 M NaOH solutions prepared in distilled water. After placing a PTFE-coated stir bar (VWR spinbar micro, 3×10 mm, Catalog No. 58948-375) into each vial, the vials were tightly capped and sealed with parafilm. The vials were stirred at 50° C. for 48 hours. Subsequent to the incubation period, the samples were analyzed using UV-Vis absorbance spectrophotometry.

In addition, the pH stability of the binding interactions was monitored in acidic pH environments. The mixtures containing 5 mg algal biochar and 1 mM FeCl₂, CuCl₂, or ZnCl₂ were transferred into 15 separate 1-dram glass vials (VWR glass vials, Catalog No. 470151-622), and the respective pH values were adjusted using 6 M H₂SO₄ prepared in distilled water. The pH of 5 different 1-dram vials containing algae biochar in the presence of one of the metal salts was adjusted to obtain five mixtures each having different pH values. In this example, the five samples were adjusted to have pH values of 6, 5, 4, 3, and 2. Similarly, mixtures, each containing the other two metal salts separately were also prepared in 1 dram vials. After placing a PTFE-coated stir bar (VWR spinbar micro, 3×10 mm, Catalog No. 58948-375) into each vial, the vials were tightly capped and sealed with parafilm. The vials were stirred at 50° C. for 48 hours. Subsequent to the incubation period, the samples were analyzed using UV-Vis absorbance spectrophotometry.

The binding interactions between the biochar and metal salt were assessed spectroscopically in an aqueous medium. 5 mg of algal biochar was weighed into each of three separate 1-dram glass vials (VWR glass vials, Catalog No. 470151-622), and 1-mM stock solutions of FeCl₂, CuCl₂, and ZnCl₂ were prepared in 15-mL scintillation vials in distilled water. 1 mL of the stock solution for each metal was added to the 1-dram glass vials containing the biochar sample. After placing a PTFE-coated stir bar (VWR spinbar micro, 3×10 mm, Catalog No. 58948-375) into each vial, the vials were tightly capped and sealed with parafilm. The vials were stirred at 50° C. for 48 hours. Subsequent to the incubation period, the samples were analyzed using UV-Vis absorbance spectrophotometry.

After treating 5-mg samples of algal biochar with 1-mM metal salts at 50° C. for 48 hours, the samples were stirred at different temperatures (20° C., 40° C., 60° C., 80° C., and 100° C.) for 6 hours, and the stability of the interactions between the metal ions and the biochar was assessed spectrophotometrically. To begin, 5 mg of algal biochar was placed into each of 18 separate 1-dram glass vials (VWR glass vials, Catalog No. 470151-622), and 1-mM stock solutions of FeCl₂, CuCl₂, and ZnCl₂ were prepared in 15-mL scintillation vials using a dichloromethane:ethanol (8:2 v/v) mixture. Then 1 mL of the stock solution for each metal was added to the 1-dram glass vials containing the biochar sample. After placing a PTFE-coated stir bar (VWR spinbar micro, 3×10 mm, Catalog No. 58948-375) into each vial, the vials were tightly capped and sealed with parafilm. The vials were stirred at 50° C. for 48 hours. Subsequently, three 1-dram vials containing Fe, Cu, or Zn adsorbed on biochar were stirred at 20° C. for 6 hours. Three other vials containing different metal salts were stirred at 40° C. Similarly, samples were stirred at 60° C., 80° C., and 100° C. for 6 hours and analyzed spectroscopically using UV-Vis absorbance spectrophotometry.

In addition, after treating 5-mg samples of algal biochar with 1-mM metal salts at 50° C. for 48 hours, the stability of the interactions between the metal ions and the biochar over time was assessed. 5 mg of algal biochar was weighed into each of 3 separate 1-dram glass vials (VWR glass vials, Catalog No. 470151-622), and 1-mM stock solutions of FeCl₂, CuCl₂, and ZnCl₂ were prepared in 15-mL scintillation vials using a dichloromethane:ethanol (8:2 v/v) mixture. Then 1 mL of the stock solution for each metal was added to the 1 dram glass vials containing the biochar sample. After placing a PTFE-coated stir bar (VWR spinbar micro, 3×10 mm, Catalog No. 58948-375) into each vial, the vials were tightly capped and sealed with parafilm. The vials were stirred at 50° C. for 48 hours. Subsequently, the samples were analyzed spectroscopically, and the absorption spectra were also recorded after fixed time intervals (24 hours, 48 hours, and 72 hours).

For the absorption measurements using UV-Vis spectroscopy, samples were diluted with HPLC-grade acetonitrile (MeCN) and analyzed over a wavelength range of 200 nm to 800 nm. Control measurements were conducted on the untreated biochar and individual metal salts to establish their respective absorption profiles, which was used in comparison with the treated biochar samples. For each spectroscopic analysis, 5 μL of the metal salt solution was introduced into a quartz cuvette containing 2 mL of MeCN, and the UV-Vis spectra were recorded. Similarly, 5 mg of algal biochar was dissolved in 1 mL of a dichloromethane:ethanol (8:2 v/v) mixture, and 5 μL of this biochar solution was diluted with 2 mL of MeCN for control analysis. The treated biochar samples were prepared by adding 5 μL of the sample into a quartz cuvette, followed by 2 mL of MeCN. The absorption spectra of all samples were observed across the wavelength range of 200 nm to 800 nm.

### DFT-Based Analysis

The ability of biochar to adsorb heavy metals can be influenced by its surface area, porosity, surface functional groups, and capacity for cation exchange. Metal-adsorption mechanisms depend at least in part on these factors, combining physical and chemical interactions. The metal-ion trapping by biochar can involve complexation, ion exchange, precipitation, and electrostatic adsorption.

Functional groups on the biochar's surface serve as active sites for Fe²⁺, Cu²⁺, and Zn²⁺ ions, enabling several adsorption mechanisms such as complexation, ion exchange, electrostatic attraction, and physical adsorption. In complexation, metal ions form coordinate bonds with oxygen atoms in functional groups by replacing protons and forming metal carboxylates or hydroxides. Ion exchange involves metal ions in biochar being replaced by other metal ions. Electrostatic attraction occurs between negatively charged carboxylate ions and positively charged metal ions, known as ion-dipole interaction. Physical adsorption occurs through van der Waals forces and cation-π interactions with the polyaromatic parts of biochar. The effectiveness of metal adsorption is influenced by the presence and concentration of functional groups and also depends on the environmental pH, which affects the protonation state of these groups.

DFT calculations were conducted to compare the selective adsorption of Fe²⁺, Cu²⁺, and Zn²⁺ ions on algal biochar. A computational model of algal biochar was constructed, focusing on functional groups responsible for adsorption. Geometry optimization for each metal-biochar system was conducted to identify the most stable configurations. Adsorption energies were calculated as the difference between the energy of the optimized metal-biochar system and the sum of the energies of isolated biochar and metal ions. Adsorption mechanisms were assessed by analyzing the electronic structure around adsorption sites. Adsorption energies were compared to determine selective adsorption, identifying the ion with the most negative adsorption energy as the preferred ion for biochar.

To simplify modeling the adsorption processes, DFT calculations were performed in the gas phase, focusing on primary interactions between ions and biochar. While the high adsorption energies can differ from those in a solid-phase system at least in part because of the absence of solvent effects and competitive adsorption, they still provide insights into the relative strength of interactions and potential adsorption mechanisms. Despite the simplifications, these results indicated biochar's selectivity for different metal ions and its potential for ion exchange. Understanding this selectivity helped inform the application of biochar for heavy-metal remediation. Additionally, competitive adsorption could affect the leaching behavior in cement-free shingles containing algal biochar, potentially altering the proportions of metals in the leachate.

### Ion Exchange and Complexation

During the pyrolysis process, organic matter in the feedstock is carbonized, and inorganic components are converted into ash. This ash is rich in minerals, including base cations (alkali metals) such as potassium, calcium, magnesium, and sodium. The concentration and type of these cations depend on the nature of the feedstock material used, especially its mineral content. For instance, feedstocks with a high mineral content, such as certain types of manure or plant-based matter, can yield biochars with higher levels of base cations. Algae, known for their ability to naturally accumulate minerals from their environment, can serve as effective feedstocks for biochar. During pyrolysis, the minerals in algae are left behind in the biochar in the form of ash, which includes base cations. However, the composition of these cations in the resulting biochar depends on the specifics of the algal feedstock and the parameters of the pyrolysis process, such as temperature and duration.

The presence of base cations plays a role in the adsorption and immobilization of heavy metals in biochar. This happens through an ion-exchange mechanism, where the base cations originally present in the biochar structure are replaced by heavy-metal cations from the environment. The biochar essentially acts like a sponge, absorbing the heavy-metal cations while simultaneously releasing the biochar's base cations. Moreover, the base cations can influence the surface charge of the biochar. Typically, biochar carries a negative charge because of the deprotonation of surface functional groups. The base cations can neutralize the surface charge, consequently increasing the pH of the point of zero charge (pH_{pze}) and thereby expanding the range of pH values at which the biochar can adsorb positively charged heavy-metal ions. This process often serves as a dominant pathway for heavy-metal adsorption in biochar.

Base cations, including potassium (K⁺), can be retained in the biochar through a combination of electrostatic interactions and complexation with the biochar's functional groups. Algal biochar has both oxygen-containing functional groups and nitrogen-containing functional groups serving as potential adsorption sites for metal ions. One of the mechanisms involved in metal-ion adsorption is the ion-exchange process. For example, K⁺ ions (an inherent base cation in biochar) could be replaced by metal ions such as copper (Cu²⁺), zinc (Zn²⁺), or iron (Fe²⁺) via ion exchange. This process involves a displacement reaction, where the less-strongly adsorbed ions (K⁺) are substituted by the more-strongly adsorbed metal ions (Cu²⁺, Zn²⁺, and Fe²⁺). Delineating this ion-exchange process and assessing the impact of the specific oxygen-containing functional groups and nitrogen-containing functional groups on the efficacy of the exchange enhanced understanding of biochar's adsorption properties.

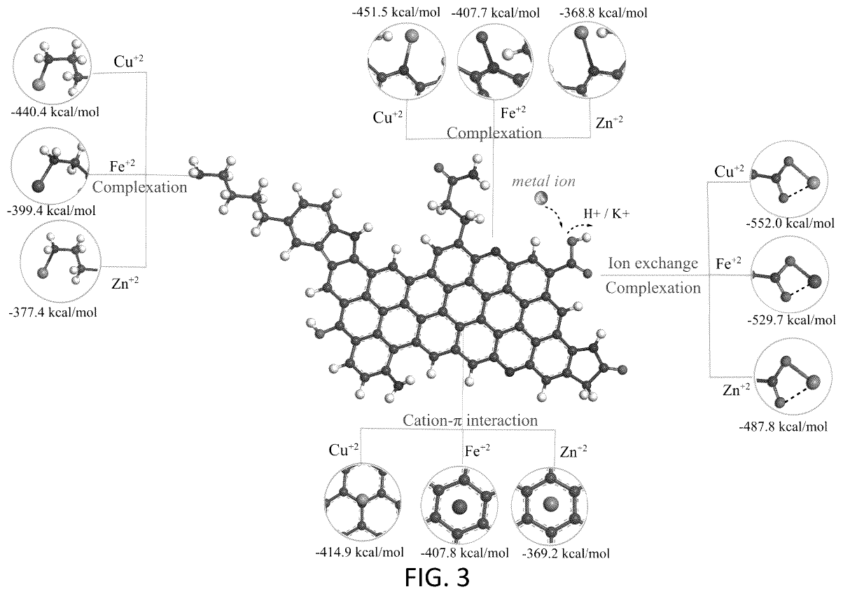

Gas-phase DFT calculations were used to assess the feasibility of ion exchange as a mechanism for the adsorption of heavy-metal ions (Cu²⁺, Zn²⁺, and Fe²⁺) onto algal biochar. The interaction energy of a biochar-bound K⁺ ion with that of biochar-bound heavy-metal ions were compared. A more-negative interaction energy for the heavy-metal ions would indicate stronger binding to the biochar, suggesting a potential preference for ion exchange. As shown in FIG. 3, the respective adsorption energies of −552.0 kcal/mol, −529.69 kcal/mol, and −487.8 kcal/mol between Cu²⁺, Fe²⁺, and Zn²⁺ and the algal biochar were more negative than the −121.8 kcal/mol energy released by the adsorption of K⁺ to the same adsorption site (—COO⁻) on the biochar. A comparison of the adsorption energy for each heavy metal suggested a selectivity order of Cu²⁺>Fe²⁺>Zn²⁺ for adsorption to algal biochar.

Nitrogen-containing functional groups such as amines, amides, and pyridines can contribute to the ion-exchange mechanism in algal biochar. These groups are inherently basic at least in part because of a lone pair of electrons on the nitrogen atom. Thus, these groups can act as active sites for the adsorption of heavy metal ions. In this process, the adsorption is facilitated by the replacement of inherent cations such as K⁺, Na⁺, Ca²⁺, or protons (H⁺ ions) attached to these functional groups. Algal biochar acts as a host matrix, facilitating the exchange of its inherent cations with heavy-metal ions present in the geopolymer matrix. This ion-exchange mechanism results in the displacement of the inherent cations of algal biochar, effectively creating vacant sites that are occupied by heavy-metal ions.

The role of nitrogen-containing functional groups (pyridine, amine, and amide) were assessed in facilitating ion-exchange. DFT calculations were carried out to compare the adsorption of inherent K⁺ ions and each of the considered heavy metals on the nitrogen containing functional groups in the algal biochar. As shown in FIG. 3, the heavy metal ions (Cu²⁺, Zn²⁺, and Fe²⁺) displayed a stronger interaction with the nitrogen-containing functional groups compared to the inherent K⁺ ions. This was supported by the more negative values of adsorption energy obtained for the heavy metals compared to K⁺ ions. For example, heavy-metal ions displayed a stronger interaction with the pyridine group (−451.5 kcal/mol for Cu²⁺, −368.8 kcal/mol for Zn²⁺, and 407.7 kcal/mol for Fe²⁺) compared to the inherent K⁺ ions' interaction with the pyridine group. These results suggested that these heavy metals can displace K⁺ ions at the nitrogen sites not only in pyridine groups but also in amine and amide functional groups. This suggested the involvement of diverse nitrogen containing functional groups in the ion exchange process and highlighted their collective potential to enhance heavy-metal adsorption in algal biochar.

In addition to the ion-exchange mechanism, the DFT calculations also provided insight into the potential for complexation between heavy-metal ions and the functional groups on algal biochar. Complexation involves the formation of a stable bond between a heavy-metal ion and a functional group, creating a complex that remains attached to the biochar. The complexation mechanisms of oxygen containing functional groups and nitrogen-containing functional groups in the adsorption of heavy metals were compared. Oxygen-containing functional groups (e.g., carboxylic and hydroxyl) present on the surfaces of algal biochar play a role in adsorbing heavy-metal ions. When biochar is subjected to an alkaline environment, such as the one created by the use of sodium hydroxide (NaOH) in the geopolymer production process, these acidic functional groups (—COOH and —OH) can be deprotonated. This leaves the functional groups negatively charged (—COO⁻ and —O⁻), which facilitates the formation of complexes with positively charged heavy-metal cations in the solution. In contrast to the aforementioned oxygen-containing functional groups, nitrogen-containing functional groups (e.g., amine, amide, and pyridine) along with certain oxygen-containing functional groups (e.g., carbonyl group (C═O)) exhibit basic characteristics. They have a high electron density on their heteroatoms (N or O) contributed by their lone pairs of electrons. These functional groups are capable of donating their electron lone pairs to form stable complexes with metal ions, a process that facilitates the adsorption of the metal ions and their potential sequestration from the solution. The formation of stable complexes shows the role these nitrogen-containing functional groups and oxygen-containing functional groups play in adsorbing and immobilizing heavy metals from the solution.

Similar to ion exchange, the DFT results and molecular modeling suggested that nitrogen-containing functional groups could also provide a pathway for the adsorption of heavy metals onto algal biochar. As shown in FIG. 3, the interaction energies suggest that nitrogen-containing functional groups displayed a favorable interaction with the heavy metals, at least in part because of the inherent basicity of nitrogen containing functional groups and their ability to donate electron pairs to form strong, stable complexes. Specifically, the values for interaction energy obtained from the DFT calculations showed that the affinity of the nitrogen-containing functional groups (pyridine, amine, and amide) for the considered metal ions (Cu²⁺, Zn²⁺, and Fe²⁺) was stronger than the affinity of the oxygen-containing functional groups for those metal ions, with a selectivity order of Cu²⁺>Fe²⁺>Zn²⁺. This result supported that nitrogen functionalities in algal biochar can serve as effective complexation sites, thereby enhancing the overall capacity for sequestering heavy-metal ions. This also highlighted the versatility of algal biochar in adsorbing heavy metal ions, offering multiple routes (ion exchange and complexation) for heavy-metal immobilization. The co-presence of both oxygen-containing functional groups and nitrogen-containing functional groups in algal biochar can promote a synergistic effect, thereby enhancing the overall capacity for heavy-metal adsorption.

### Cation-π Interactions

A component of the DFT analysis on the adsorption of Zn, Cu, and Fe ions onto algal biochar is their potential interaction through cation-π mechanisms. This is particularly relevant given that a defining structural feature of algal biochar is its polyaromatic segments, which are areas rich in π electrons. The cation-π interactions are a result of electrostatic attraction between the positive charge of the metal cation and the regions of negative potential in the biochar's π-system. In aromatic systems, such as the polyaromatic core in algal biochar, the π electrons are delocalized and form a cloud of electron density above and below the plane of the molecule. These negatively charged clouds can attract and interact with positively charged metal cations, forming cation-π interactions. As shown in FIG. 3, in addition to functional groups, the polyaromatic core of the algal-biochar model has regions of low electrostatic potential, indicating a high concentration of electron density. These regions, therefore, function as π-donors, which have a propensity to attract heavy metal cations.

The energy results obtained from the DFT calculations provide insight into the strength and nature of the cation-π interactions. For instance, the adsorption energy onto the polyaromatic segments was −414.9 kcal/mol for Cu²⁺, −407.8 kcal/mol for Fe²⁺, and −369.2 kcal/mol for Zn²⁺. These values suggested that the metal ions are being strongly adsorbed onto the biochar via cation-π interactions. The adsorption energy for Cu²⁺ was found to be the most negative among the three metal ions, indicating that Cu²⁺ ions might have the highest affinity for the π-rich regions of the biochar, followed by Fe²⁺, then Zn²⁺.

The observed energy trends in the cation-π interactions of Cu²⁺, Fe²⁺, and Zn²⁺ with algal biochar's π system could be attributed at least in part to their ionic radii, charge densities, and specific electronic configurations. Among Cu²⁺, Fe²⁺, and Zn²⁺ ions, Cu²⁺ and Fe²⁺ ions are known to be able to form strong π-complexes at least in part because of their specific electronic configurations, while Zn²⁺ is typically less capable of forming such complexes at least in part because it has a fully filled [Ar] 3d configuration. This could contribute to why Cu²⁺ and Fe²⁺ ions have stronger interactions than Zn²⁺ ions. In addition, transition metals such as Cu²⁺ and Fe²⁺, which have partially filled d orbitals, can engage in π-backbonding with the π-system, further strengthening the cation-π interaction. The term “π backbonding” describes an interaction where an electron-rich species donates electron density to a metal center, and the metal donates electron density back into the π* (anti-bonding) orbitals of the ligand. The concept is commonly applied in the context of transition metal complexes, where the central metal atom or ion has d orbitals that are partially filled or empty. The π electron cloud of algal biochar can act as the ligand, donating electron density to the metal ion and accepting electron density back into its π* orbitals. This back-donation can enhance the stability of the cation-interaction, making it energetically more favorable. In particular, Cu²⁺ exhibited the highest affinity for the π-system among the three metal ions. This could be due at least in part to two factors: a favorable size match between Cu²⁺ and the aromatic system, and the capability of Cu²⁺ to form strong π backbonding because of its electronic configuration. Specifically, Cu²⁺ has a +2 charge and a [Ar] 3d9 configuration, which could enhance its interaction with the π electron cloud despite its smaller size. Furthermore, Cu²⁺ has a tendency to engage in π-backbonding, which involves the donation of electron density from the π cloud of the polyaromatic core to the empty orbitals of the metal ion, strengthening the cation-π interaction. These factors, such as the electronic configuration, likely contributed to the trend in adsorption energy observed for the interaction of these metal ions with algal biochar.

The observed positions of the metal ions provided information about the cation π interactions and contributed to understanding the efficacy and selectivity of heavy-metal adsorption by biochar. Referring to FIG. 3, the molecular modeling showed that Zn²⁺ and Fe²⁺ preferred to interact with the center of a single benzene ring in the polyaromatic system, while Cu²⁺ preferred the junction point of three benzene rings. The central position above a benzene ring can be favorable for cation-π interactions at least in part because of the symmetric arrangement of the π electrons below the metal ion. However, the interaction at the junction of three benzene rings for Cu²⁺ suggests a multicenter interaction, where the Cu²⁺ ion is interacting with the π electrons from multiple rings simultaneously. Cu²⁺ could be capable of forming stronger or more stable multicenter interactions at least in part because of its electronic configuration and its well-matched size.

### UV-Vis Spectroscopic and Thermogravimetric Analysis of Metal-Biochar Interactions

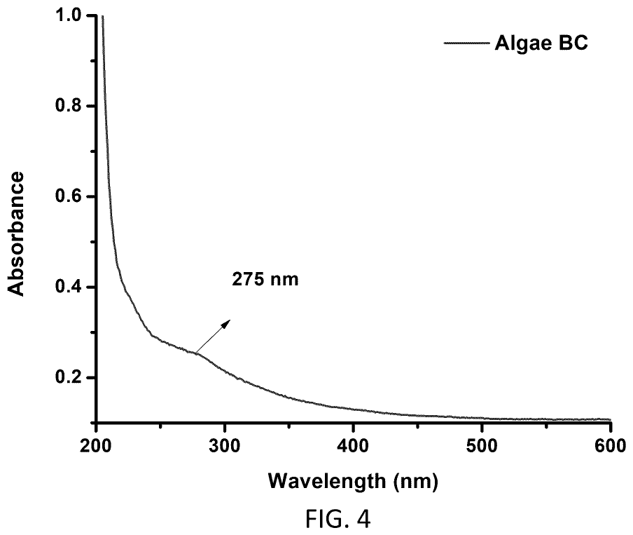

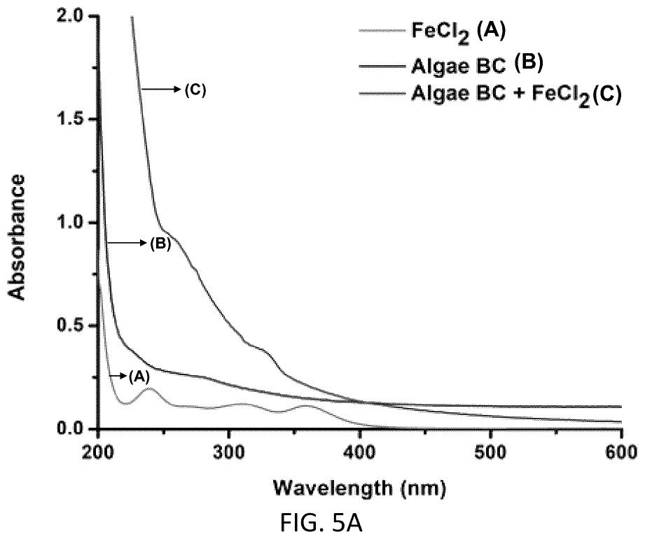

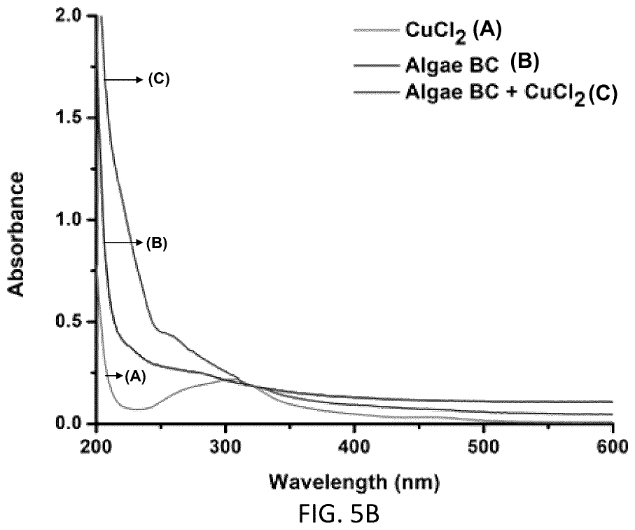

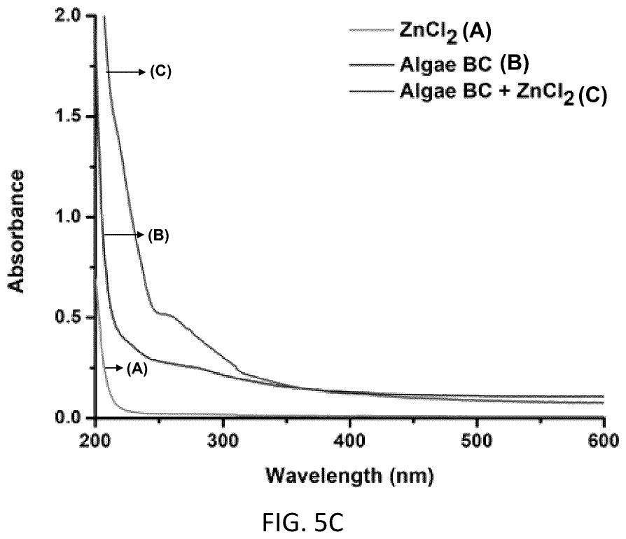

Spectroscopic analysis of untreated algal biochar, metal salts, and treated algal biochar was performed across a wavelength range of 200 nm to 800 nm. When solubilized in a mixture of dichloromethane:ethanol (8:2 v/v), the metal salts exhibited distinctive absorption maxima (λmax) in the UV-Vis spectrum, as shown in FIG. 4. Specifically, FeCl₂ demonstrated sharp peaks at 240 nm, 310 nm, and 360 nm; CuCl₂ showed a broad peak at 305 nm and a medium-intensity peak at 460 nm. In contrast, ZnCl₂ did not exhibit any characteristic peaks in the analyzed region. The spectrum of algal biochar was typically broad and lacked distinct features, at least in part because of the overlapping absorption bands from various chromophores. A shoulder at 275 nm, indicating n-π* and π-π* transitions, was observed in the algal biochar; which can be attributed at least in part to the presence of heteroatom-containing functional groups and a conjugated polyaromatic structure. As shown in FIGS. 5A, 5B, and 5C, with the addition of metal salts, the samples of treated algal biochar exhibited altered absorption profiles. Treatment with FeCl₂ resulted in the emergence of shoulder peaks at 256 nm and 325 nm, while treatment with CuCl₂ resulted in a medium-intensity shoulder peak at 255 nm. These changes suggested interactions between the algal biochar and the Fe(II) and Cu(II) ions, potentially through cation-π interactions, exchange interactions, or metal-binding mechanisms. The ZnCl₂-treated biochar sample showed a shoulder peak at 257 nm.

To complement the spectroscopic analysis and elucidate the interactions between metal ions and algal biochar, the biochar's thermal stability was assessed, as it influences capability for carbon sequestration. TGA was used to evaluate the thermal stability of both untreated and metal-treated biochar samples under an inert atmosphere. The TGA data, indicating the percentage of weight loss, provided insight into the samples' relative stability. Upon gradual heating at a rate of 10° C./min, the degradation observed below 200° C. indicated the presence of volatile organic carbon. Between 200° C. and 380° C., labile organic components such as cellulose and aliphatic carbons were predominantly released. Degradation occurring from 380° C. to 475° C. corresponded to the loss of recalcitrant carbon, typically lignin and its derivatives. Refractory organic carbon, including polycondensed lipids and aromatic carbon, decomposed between 475° C. and 600° C. Above 600° C., the loss was attributed at least in part to inorganic carbonates. The peak degradation temperature, reaching 1000° C., was found to be an indicator of thermal stability in an inert atmosphere. The TGA results revealed that the thermal degradation profiles of algal biochar were altered in the presence of different metal salts.

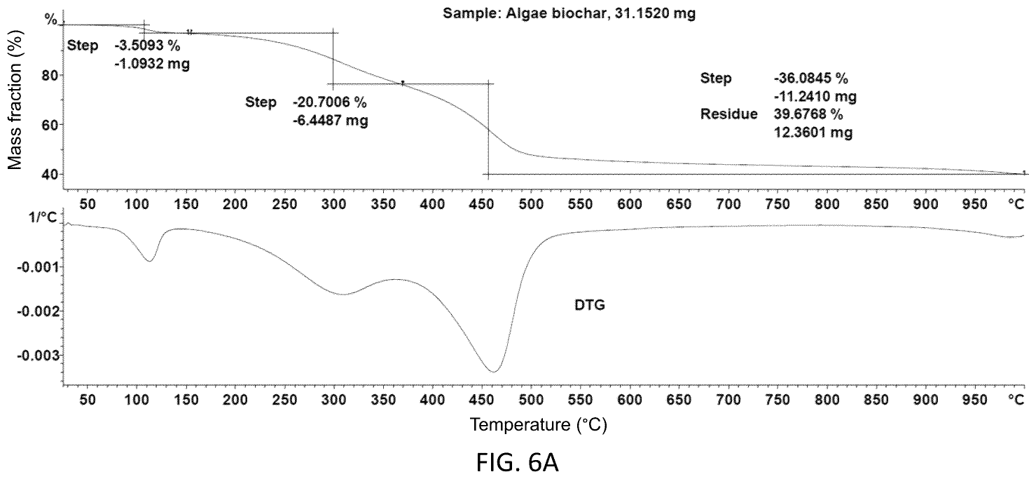

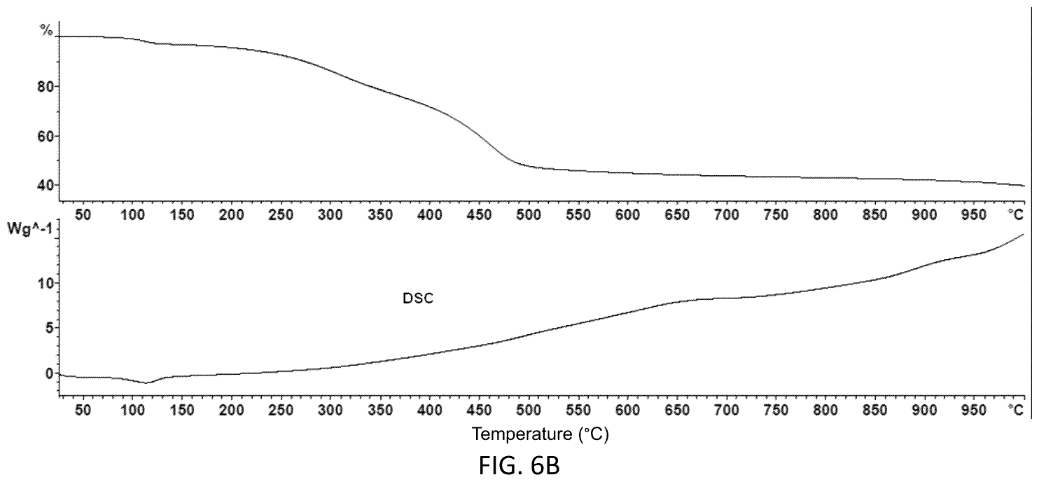

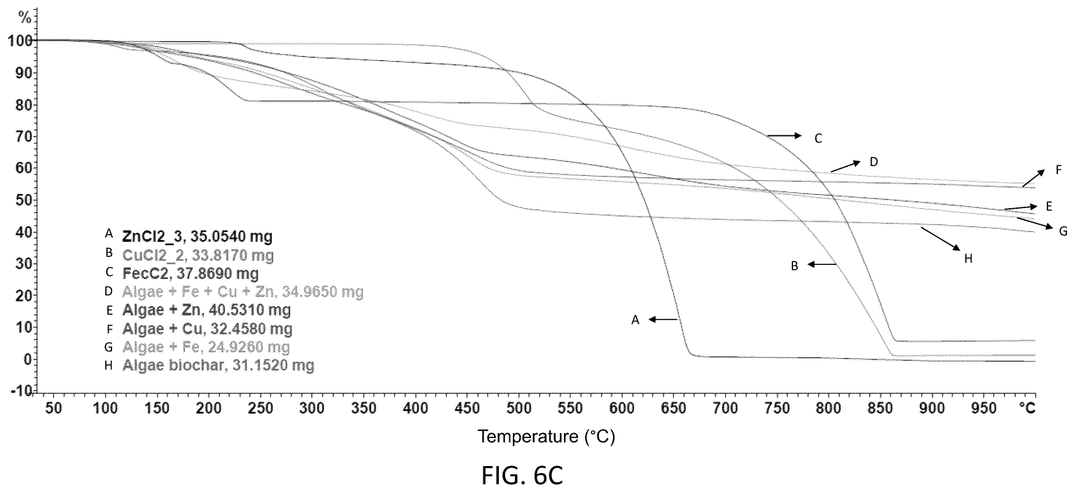

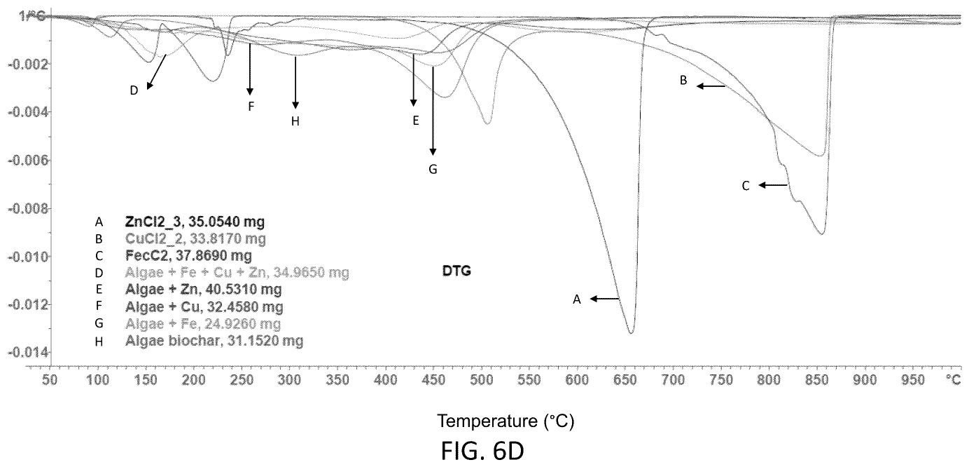

As shown in FIG. 6A, the TGA/DTG curves showed the characteristic thermal degradation of algal biochar. Initially, algal biochar underwent a 3.5% mass loss at 115° C., attributed at least in part to the volatilization of organic content. Subsequently, about 20% of the mass is lost at 300° C. at least in part because of the degradation of labile organic components such as cellulose, carbohydrates, and aliphatic carbon. At 460° C., the biochar lost an additional 36% loss of its initial mass, primarily from the decomposition of recalcitrant organic carbon (e.g., lignin). Beyond this temperature, the biochar remained stable up to 1000° C., with a 40% residue. FIG. 6B shows the heat flow associated with the degradation process, indicating an exothermic reaction. This was supported by the DSC curve (lower graph), which shows an exothermic peak persisting until 1000° C.

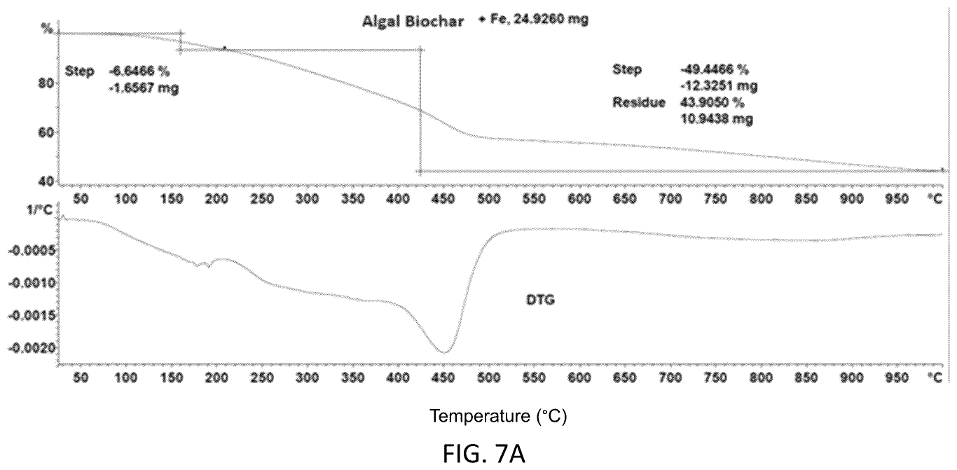

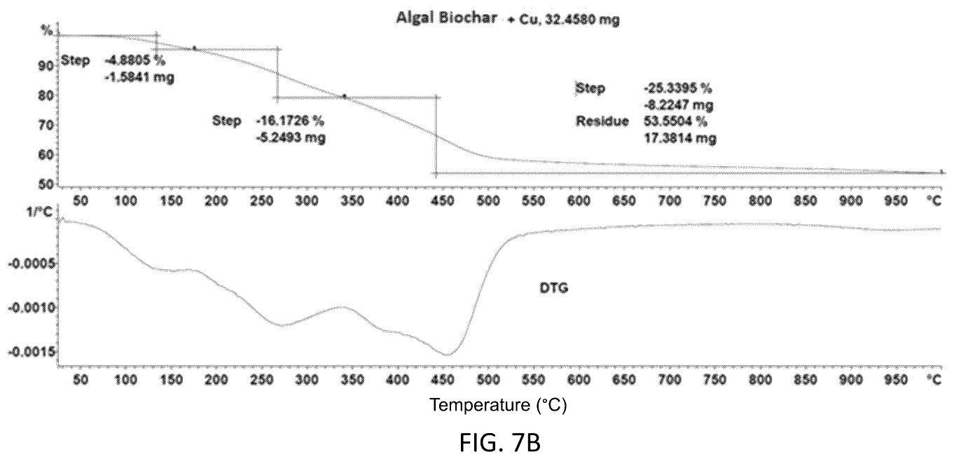

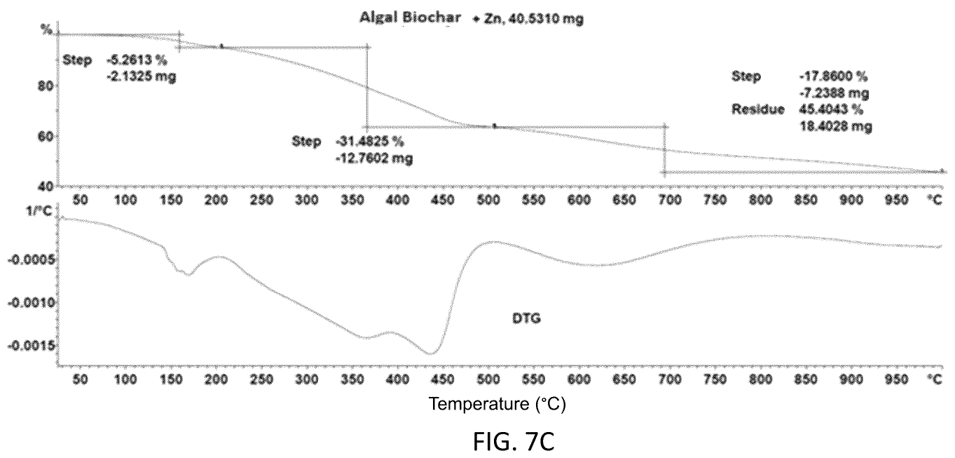

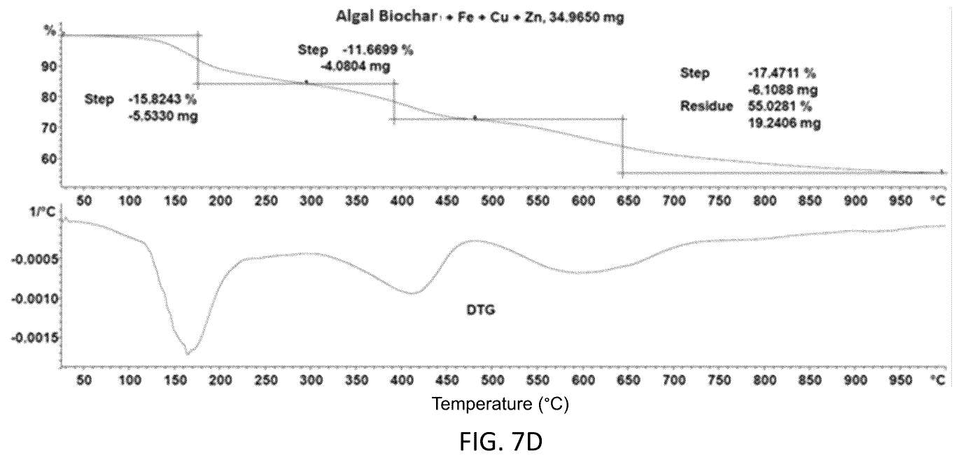

As shown in FIG. 7A, when the algal biochar was treated with FeCl₂, a mass loss of approximately 6.6% was observed between 170° C. and 200° C., and the evolution of recalcitrant organic carbon occurred at 450° C. As shown in FIGS. 6C and 6D, FeCl₂ alone exhibited a 26% mass loss at temperatures of 150° C. and 220° C., undergoing complete degradation, with the remainder of the mass lost between 750° C. and 850° C. The negligible release of volatile organic carbon at temperatures below 150° C. and above 500° C. in the FeCl₂-treated algal biochar suggested an interaction of functional groups on the biochar surface with Fe(II) ions. This was deduced from the differences between the degradation phases of the treated biochar and the FeCl₂ control.

In the presence of CuCl₂, the degradation of algal biochar occurred evenly between 125° C. and 460° C., resulting in a 46% loss of both volatile organic and recalcitrant organic carbon content, as shown in FIGS. 5C and 6B. CuCl₂ independently exhibited a 25% mass loss at 505° C. and continued to degrade gradually beyond 580° C. until 860° C., as shown in FIG. 6C. Compared to the metal control, the DTG curves of algal biochar with CuCl₂ suggested that Cu(II) formed complexes with various functional groups on the biochar, potentially creating compounds of high molecular weight.

When the algal biochar was treated with ZnCl₂, the algal biochar showed a 37% loss of its volatile and recalcitrant content between 150° C. and 450° C., as shown in FIG. 7C, and an additional 18% loss of refractory organic and aromatic carbon from 550° C. to 700° C., as shown in FIGS. 6C and 6D. ZnCl₂ primarily degraded between 600° C. and 660° C., suggesting that the interactions between Zn(II) and algal biochar might be weaker than those between Cu(II) and algal biochar.

The heat-flow analysis of algal biochar treated with metal salts revealed the absence of characteristic endothermic peaks that are otherwise observed at specific temperatures for FeCl₂, CuCl₂, and ZnCl₂, which suggested an interaction between the metals and the biochar. Untreated FeCl₂ showed three endothermic peaks, at 148° C. (ΔH=−236.35 J/g), 217° C. (ΔH=−419.50 J/g), and 684.6° C. (ΔH=−199.65 J/g). CuCl₂ showed two peaks, at 86.78° C. (ΔH=−23.64 J/g) and 497.74° C. (ΔH=−483.01 J/g). ZnCl₂ showed three peaks, at 233.53° C. (ΔH=−56.71 J/g), 281.49° C. (ΔH=−32.37 J/g), and 645.95° C. (ΔH=−296.75 J/g). The endothermic peaks for algal biochar were absent for algal biochar treated with FeCl₂ or CuCl₂, indicating an alteration due at least in part to interaction. In contrast, algal biochar treated with ZnCl₂ showed endothermic peaks at 466.21° C. (ΔH=−85.51 J/g) and 820.69° C. (ΔH=−821.74 J/g) that were not present in untreated algal biochar. The presence of these distinct thermal events, along with an exothermic drift, supported that electrostatic or metal-exchange interactions were occurring between the metal ions and the biochar's surface functional groups.

After demonstrating the algal biochar's potential to adsorb different metal salts, the ability of the biochar to adsorb the respective metal salts at lower concentrations was assessed, considering the differences of heavy metal concentrations in real-world applications. Stock solutions of the metal salts were prepared at varying concentrations (e.g., 10 mM, 5 mM, 4 mM, 3 mM, 2 mM, and 1 mM) and biochar was subjected to each of these concentrations of the three metal salts. Binding interactions of were studied spectroscopically.

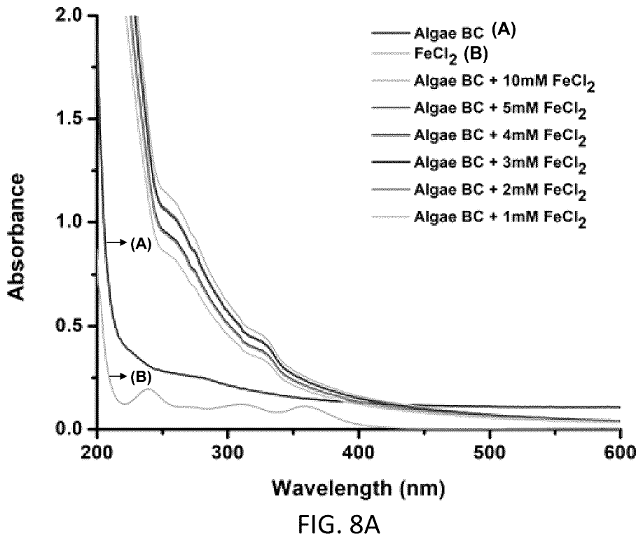

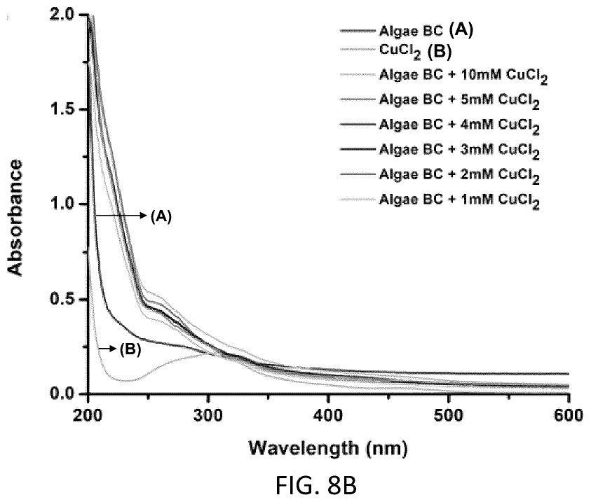

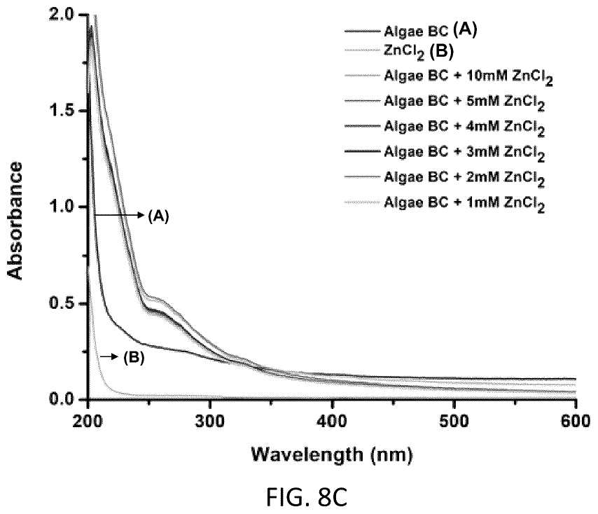

Spectroscopic analysis of untreated algal biochar, metal salts, and treated algal biochar was performed across a wavelength range of 200 nm to 800 nm. With the addition of metal salts, even at lower concentrations up to 1 mM, it was observed that the treated algal biochar exhibited altered absorption profiles. As shown in FIG. 8A, upon the treatment with FeCl₂, the algae biochar displayed characteristic shoulder peaks at 256 nm and 325 nm. Biochar treated with CuCl₂ exhibited a medium-intensity shoulder peak at 255 nm, as shown in FIG. 8B. For ZnCl₂ treatment of biochar, a 257 nm shoulder peak was observed, as shown in FIG. 8C.

The spectroscopic assessment of various concentrations of the stock solutions showed that 1 mM metal stock was able to demonstrate the adsorption capabilities of the algal biochar. Therefore, 1 mM metal stock solution was adsorbed onto the surface of biochar, and the stability of these interactions was evaluated at different pH levels. pH and thermal stability are useful adsorbent properties of a biochar, as they indicate the affinity of the biochar toward the adsorbate and biochar's potential to be applied in water or soil for longer periods.

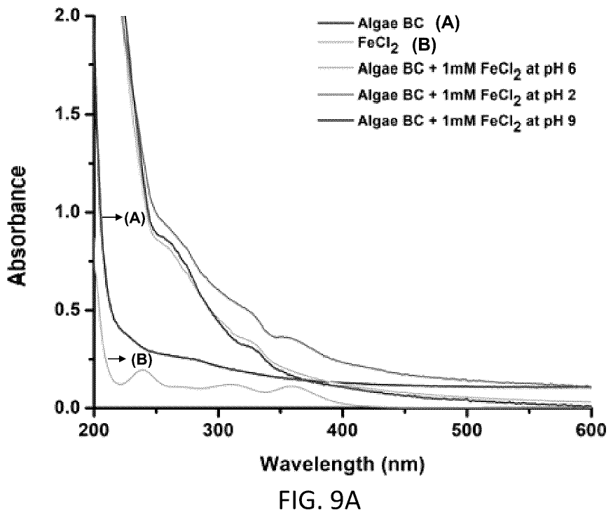

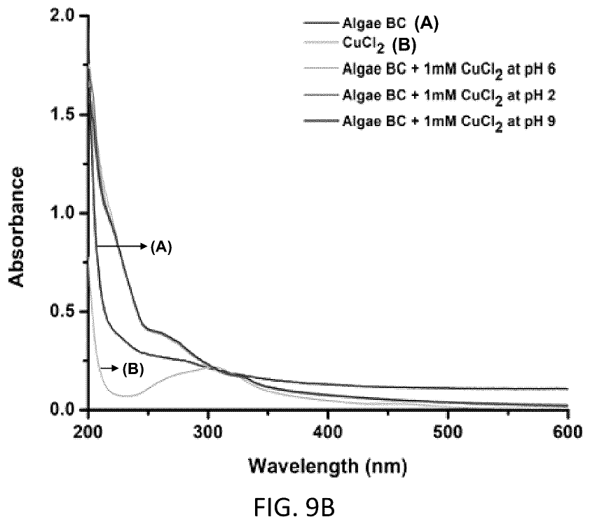

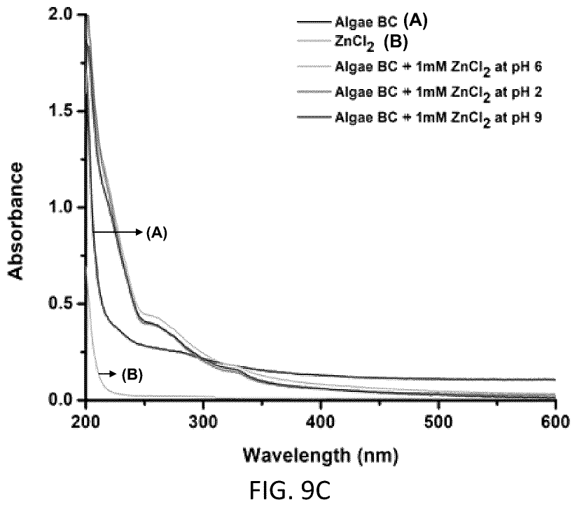

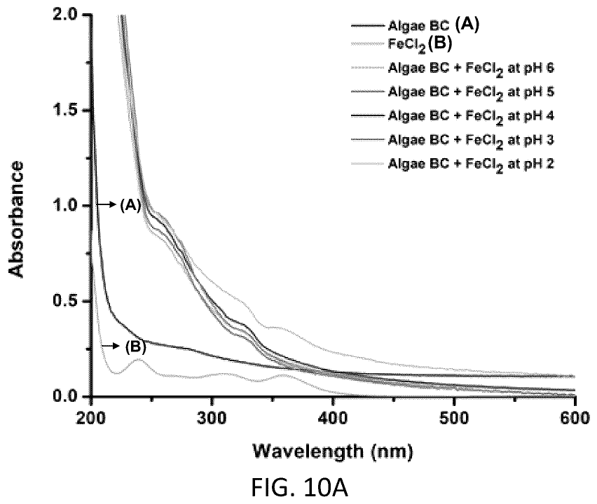

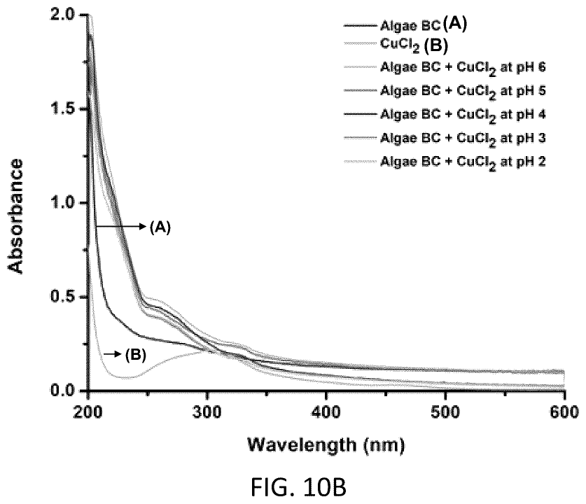

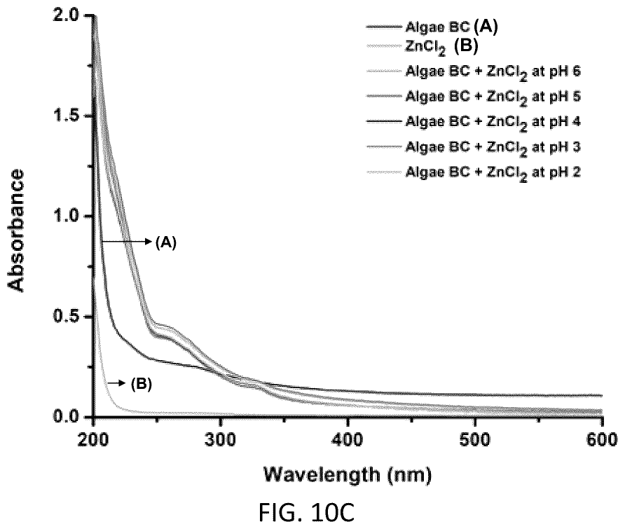

Spectroscopic analysis was performed across a wavelength range of 200 nm to 800 nm for treated algal biochar and metal salts (and for untreated algal biochar and metal salts as control samples). It was observed that the binding event was stable at acidic, neutral, and alkaline pH for CuCl₂ and ZnCl₂, as shown in FIGS. 9A-9C. However, as shown in FIG. 9A, under acidic conditions, FeCl₂ was observed to be leaching out of the medium, indicated by the observance of characteristic absorption peaks of FeCl₂ at 360 nm. This effect was further assessed by observing the binding interactions between FeCl₂ and biochar at varying acidic pH levels. This effect was also assessed for CuCl₂ and ZnCl₂, as shown in FIG. 9B and FIG. 9C, respectively. Referring to FIGS. 10B and 10C, the CuCl₂-treated biochar and the ZnCl₂-treated biochar displayed stability in acidic pH environments. In contrast, FeCl₂-treated biochar was stable up to pH=3 and further acidic conditions favored Fe-metal leaching, as shown in FIG. 10A. The results showed that the Cu and Zn metals can be removed using algal biochar in a wider pH range (2-9) and Fe can be removed using algal biochar in a pH range of 3-9, which suggested that the biochar can be applied to efficiently adsorb these metals from contaminated samples.

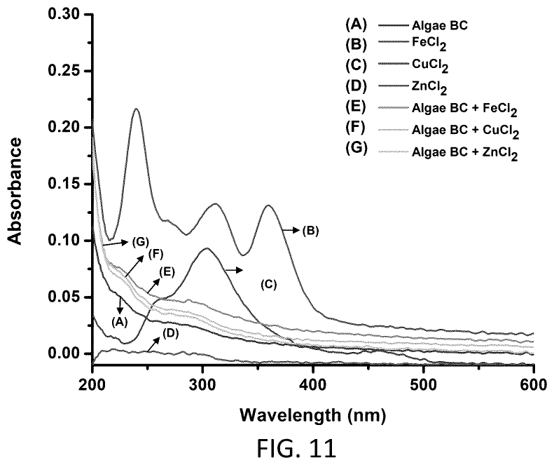

Assessing the binding affinity of the biochar toward the metal salts in an aqueous medium can provide insight into understanding if the biochar can be potentially applied to adsorb metal ions in contaminated water samples. The biochar was treated with metal salts in distilled water, and the spectroscopic analysis was performed. The samples were not completely soluble in water, even at 50° C. The controls of the algal biochar as well as the metal salts were also recorded in water. As shown in FIG. 11, no characteristic peak upon binding with the metal salt was observed and the spectroscopic profile of the treated algal biochar matched with that of the untreated biochar, indicating that the binding event may not have taken place. This could be attributed at least in part to poor solubility of the biochar in water in comparison to the dichloromethane:ethanol that was used in the rest of the experiments.

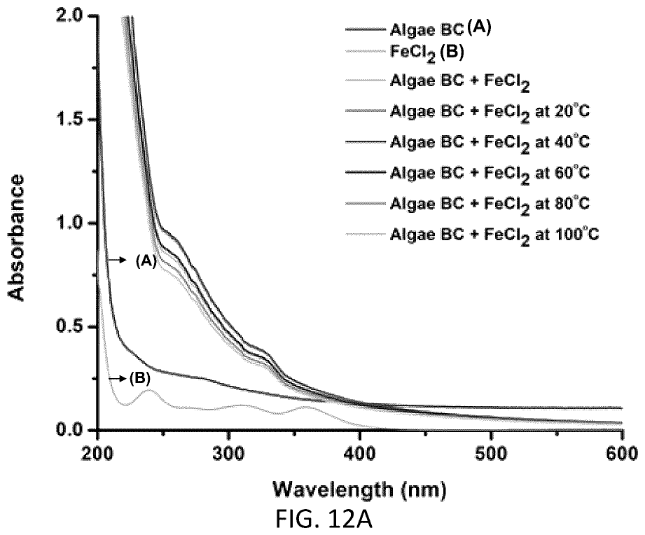

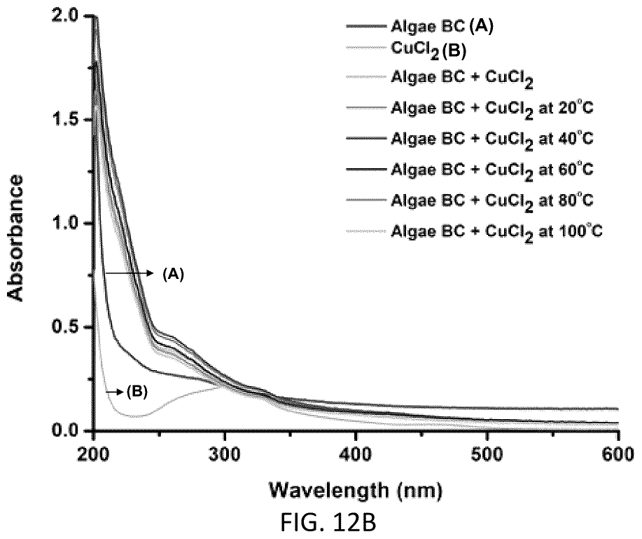

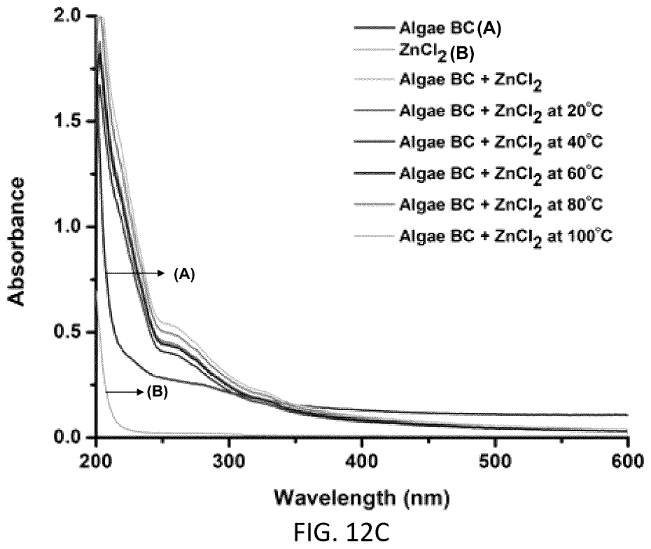

After assessing the pH stability of the binding interactions, the temperature stability of the binding event was also assessed. As shown in FIGS. 12A-12C, the treated biochar samples were subjected to different temperatures, and the samples were then analyzed spectroscopically. The treated biochar samples displayed thermal stability up to 100° C. in the presence of all three metal salts.

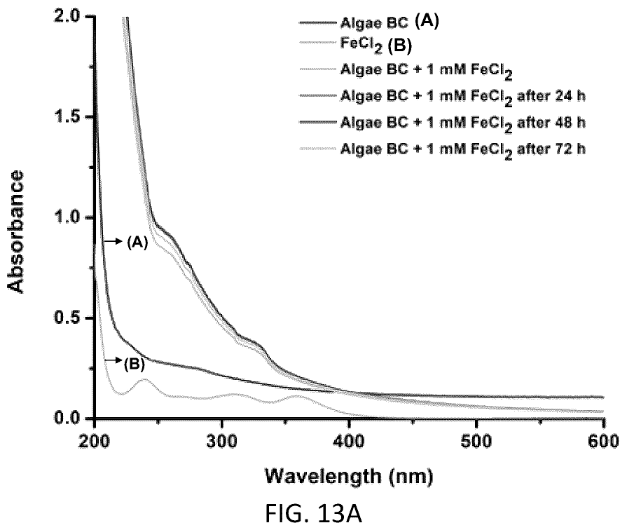

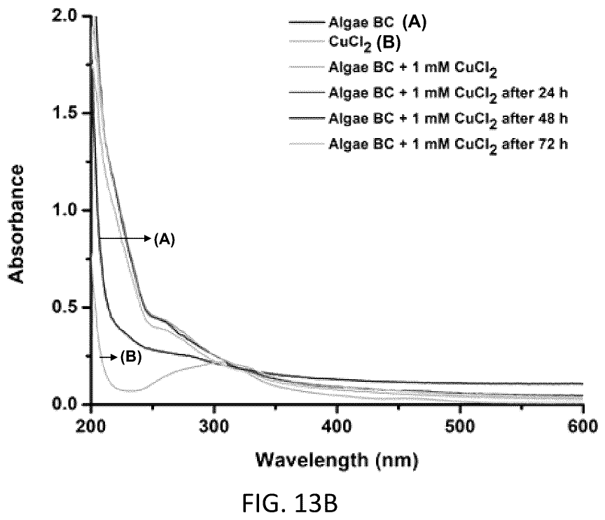

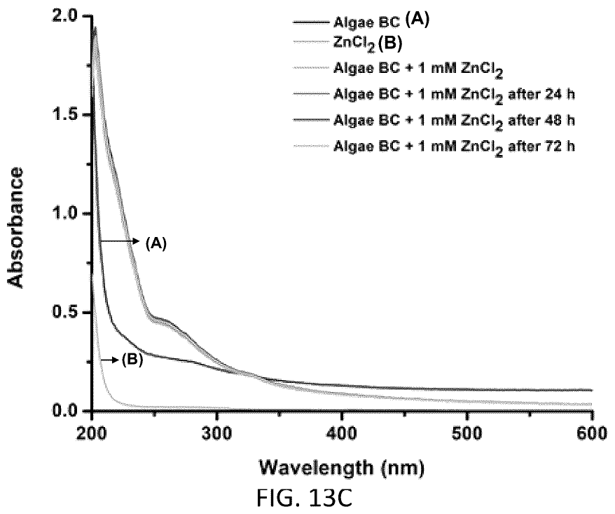

The treated biochar samples were assessed spectroscopically after fixed time intervals, to understand the equilibrium of the exchange mechanism after the temperature drops to room temperature. The biochar was stirred with the metal salts at 50° C. for 48 hours. From that point, after fixed time intervals of 24 hours, 48 hours, and 72 hours, the samples were analyzed spectroscopically and the absorption spectra were recorded. The results indicated that the adsorption of the metal salts onto the surface of the biochar was stable at room temperature, even 72 hours after binding, as shown in FIGS. 13A, 13B, and 13C.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A composite comprising:
a base material comprising mine tailings; and
biochar.

2. The composite of claim 1, wherein the base material further comprises clay, laterite, zeolite, volcanic ash, natural pozzolans, fly ash, red mud, furnace slag, rice husk ash, waste incinerator bottom ash, silica fume, waste glass, coal gangue, or a combination thereof.

3. The composite of claim 2, wherein the mine tailings comprise one or more heavy metals.

4. The composite of claim 3, wherein the one or more heavy metals comprise Cr, Co, Ni, Cu, Zn, Mn, Mo, Rh, Pd, Cd, In, Sn, Ti, As, Sr, Ag, Fe, Bi, Pt, Pb, or a combination thereof.

5. The composite of claim 4, wherein the one or more heavy metals comprise Cu.

6. The composite of claim 1, wherein the biochar is derived from hydrothermal liquefaction.

7. The composite of claim 1, wherein the biochar has a selectivity order of Cu²⁺>Fe²⁺>Zn²⁺ for adsorption.

8. The composite of claim 1, wherein K⁺ ions of the biochar are displaced from a nitrogen site of amines, amides, or a combination thereof.

9. The composite of claim 1, wherein the biochar comprises algal biochar.

10. The composite of claim 9, wherein the algal biochar is derived from Cyanidioschyzon merolae.

11. The composite of claim 1, further comprising aggregate.

12. The composite of claim 11, wherein the composite comprises about 55 wt % to about 80 wt % of the aggregate.

13. The composite of claim 1, further comprising an alkali activator.

14. The composite of claim 13, wherein the alkali activator comprises NaOH, KOH, LiOH, Na₂SiO₃, Na₂CO₃, K₂CO₃, Li₂CO₃, CaO, NaAlO₂, AlCaO, Al₂CaO₄, or a combination thereof.

15. The composite of claim 1, wherein the composite comprises about 0.3 wt % to about 30 wt % of the biochar.

16. The composite of claim 1, wherein the composite comprises about 10 wt % to about 35 wt % of the base material.

17. A method of preparing a composite, the method comprising:
combining a base material comprising mine tailings and an alkali activator to yield a mixture;
polymerizing the mixture to yield a geopolymer material; and
combining the geopolymer material and biochar to yield the composite.

18. The method of claim 17, wherein the base material further comprises clay, laterite, zeolite, volcanic ash, natural pozzolans, fly ash, red mud, furnace slag, rice husk ash, waste incinerator bottom ash, silica fume, waste glass, coal gangue, or a combination thereof.

19. The method of claim 17, wherein the alkali activator comprises NaOH, KOH, LiOH, Na₂SiO₃, Na₂CO₃, K₂CO₃, Li₂CO₃, CaO, NaAlO₂, AlCaO, or Al₂CaO₄, or a combination thereof.

20. The method of claim 17, wherein the biochar comprises algal biochar.
